(19) United States
(12) Patent Application Publication
(10) Pub. No.: US 2026/0044869 A1
(43) Pub. Date: Feb. 12, 2026

(54) REAL-TIME DYNAMIC MODEL CALIBRATION FOR LEAD SCORING SYSTEMS

(71) Applicant: Leadscorz Inc., Seattle, WA (US)

(72) Inventors: Bernard Patrick Murphy, Seattle, WA (US); Santiago Diez-Pérez, León (ES)

(21) Appl. No.: 19/213,871

(22) Filed: May 20, 2025

Related U.S. Application Data
(60) Provisional application No. 63/650,043, filed on May 21, 2024.

(51) Int. Cl. G06Q 30/0201; G06Q 30/0204

(52) U.S. Cl. CPC G06Q 30/020121; G06Q 30/0204

(57) ABSTRACT

A system and method for dynamic calibration of predictive lead scoring models based on real-time feedback data. A binary classifier converts lead records to conversion probability scores. Leads are clustered into performance segments which are mapped to grade categories. As feedback on lead outcomes is received, cluster definitions and grade mapping are automatically recalibrated to maintain accuracy without retraining the core classifier. Real-time feedback capture and relative grading enable use of stable decision rules even as underlying lead patterns shift.

### CROSS REFERENCE TO RELATED APPLICATIONS

The present application claims priority to U.S. Provisional Application No. 63/650,043, entitled “Real-Time Dynamic Model Calibration for Lead Scoring Systems”, and filed on May 21, 2024. The entire contents of the above-listed application are hereby incorporated by reference for all purposes.

### TECHNICAL FIELD

The present disclosure relates generally to lead scoring systems and more specifically to techniques for dynamically calibrating predictive models used in lead scoring systems based on real-time feedback data.

### BACKGROUND

Lead scoring systems are used by organizations to prioritize and optimize engagement with potential customers or prospects. Predictive models, such as binary classifiers, are often employed to estimate the likelihood that a given lead will convert to a desired outcome, such as a sale. However, the performance of these models can degrade over time as trends and behaviors evolve. Recalibrating the models typically requires retraining them on updated historical datasets, which can be time and resource intensive. There is a need for lead scoring systems that can dynamically adapt their predictive models to changing real-world conditions without requiring full model retraining. For example, an organization relying on a model's efficacy to support real-time decision making with respect to lead purchasing, prioritization or dispositioning, has no way of determining the relative efficacy of a refreshed model vs their current model until/unless they create one. A goal of the present invention is to solve these needs.

### SUMMARY

The disclosed invention provides a system and method that enable real-time calibration of a predictive lead scoring model without repeatedly retraining the underlying classifier. A lead intake module receives and normalizes incoming lead data, which is then processed by a binary classifier to generate an initial probability score for each lead. A clustering module groups the leads into performance-based segments according to these scores and relevant attributes, while a mapping module assigns each segment to a specific grade category, such as A, B, or C, based on aggregate outcomes. Real-time feedback data is captured to identify actual conversion results and is used to continuously update how clusters map to letter-grade outputs. This architecture ensures the system can adjust lead grading thresholds and reflect evolving trends in conversion behavior without recalculating the model's core parameters. A rules engine allows filtered or prioritized routing of leads to end users, such as marketing managers or enrollment counselors, based on the dynamic grade assignments. Additionally, a method is disclosed that describes ingesting leads, generating probability scores, clustering leads, mapping the clusters to grades, capturing ongoing outcome data, and recalibrating the cluster-grade mappings in response to that data for new leads. Through this two-stage approach, the system supports continuous adaptation of lead quality assessments, accommodating shifts in consumer behavior while retaining the stability of the trained classifier.

### BRIEF DESCRIPTION OF THE DRAWINGS

FIG. 1 is a block diagram of a dynamic lead scoring system in an illustrative embodiment.

FIG. 2 is a flow diagram illustrating a method for real-time model calibration in an illustrative embodiment.

FIGS. 3A-3C depict example user interfaces of the lead scoring system in an illustrative embodiment.

### DETAILED DESCRIPTION OF ILLUSTRATIVE EMBODIMENTS

### Overview

The present disclosure describes a dynamic lead scoring system that automatically calibrates predictive models in real-time based on feedback data, without requiring models to be retrained. The system combines a binary classifier for predicting lead conversion probabilities with a clustering model that segments leads into performance-based grades. As real-time lead outcome data is captured, the system re-evaluates the mapping of probability scores to grades and adjusts this mapping to maintain accuracy over time. This allows lead scores to adapt to changing trends and consumer behavioral patterns even as the core classification model remains fixed.

The dynamic calibration process is fully automated and utilizes a relative grading scheme, which enables the consistent application of decision rules and filters even as the underlying lead distribution shifts. This provides advantages over static lead scoring systems, which require frequent manual model updates to avoid accuracy degradation. Another benefit of the dynamic calibration process is that it facilitates monitoring the performance of lead sources to enable the lead buyer to make interim (i.e., between model refreshes) adjustments to lead spend allocations as a means of improving conversion results.

Other benefits of the system include:
Ability to leverage real-time feedback from sales and marketing systems to continuously evaluate score accuracy and adapt grades.
Ability to monitor the performance of multiple lead sources in real-time, between model refreshes, to support adjustments to lead vendor and marketing channel spend allocations.
Two-stage modeling architecture separating classification and clustering to allow dynamic adjustments without classifier retraining.
Automated feature engineering pipelines to transform raw lead data into predictive model inputs.
Customizable filtering and prioritization rules that leverage dynamic grades to route high-potential leads to appropriate sales resources.
Continuous monitoring of model performance and data drift to trigger alerts and model retraining when needed.

By dynamically calibrating lead scores in real-time while preserving the core predictive model, the system offers improved accuracy, computational efficiency, and business agility compared to conventional lead scoring approaches. The following sections describe the technical implementation in more detail.

### System Architecture

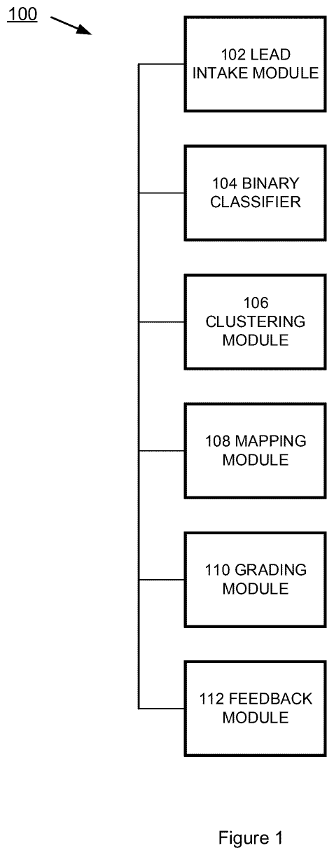

Referring to FIG. 1, the lead intake module 102 collects lead records from the client's CRM system, third-party lead providers, and other sources. Leads are standardized into a consistent schema, cleansed of errors and duplicates, and enriched with additional first and third-party data attributes.

The binary classifier 104 is a machine learning model trained to predict the probability that a given lead will convert to a positive outcome, such as becoming a sales opportunity or a closed sale/new customer. The model is trained on large volumes of historical lead data and conversion feedback. Various algorithms may be used including logistic regression, decision trees, neural networks, and ensemble methods. The classifier takes a lead record as input and outputs a conversion probability score between 0 and 1.

The clustering module 106 groups scored leads into a set of clusters or segments based on their conversion probabilities and other selected attributes, such as lead source, product interest, or geography. Clustering is performed using an unsupervised machine learning algorithm such as k-means. The number of clusters is determined empirically and may be adjusted over time as the size and composition of the lead dataset evolves.

The mapping module 108 evaluates the aggregate composition and outcomes of each lead cluster to assign them to graded categories. For example, the cluster with the highest proportion of converted leads may be designated as “A” leads, the second highest as “B” leads, and so on. This mapping of probability scores to grade levels is dynamic and is continuously recalibrated as new feedback data is received. In another implementation, more than one cluster may be mapped to a single grade label, in which case clusters are “grouped” by performance and then the average conversion rate of the grouped clusters is calculated and compared against the grading scale to determine the appropriate grade label to apply to these clusters.

The grading module 110 outputs the final lead scores to the client system as letter grades. Using a relative grading scheme that normalizes the relative quality score output maintains consistency of decision rules and filters, even as the underlying lead distribution and clustering may shift over time.

The feedback module 112 captures real-time outcomes for scored leads. Leads are marked as positive (converted) or negative based on the client's criteria, such as becoming a sales qualified opportunity, submitting a credit application, or purchasing a product. Feedback data is used to evaluate and adjust cluster definitions, grade assignments, and the accuracy of the binary classification model.

The system components are implemented as a combination of software modules and database objects. The binary classifier 104 and clustering module 106 are implemented using common machine learning libraries such as scikit-learn, TensorFlow, or SparkML. Results are stored in a relational database or other structured data store. A web-based portal is provided for client users and administrators to view lead scores, configure decision rules, and monitor model efficacy, lead source performance, and lead filtering rules performance over time.

### Operation

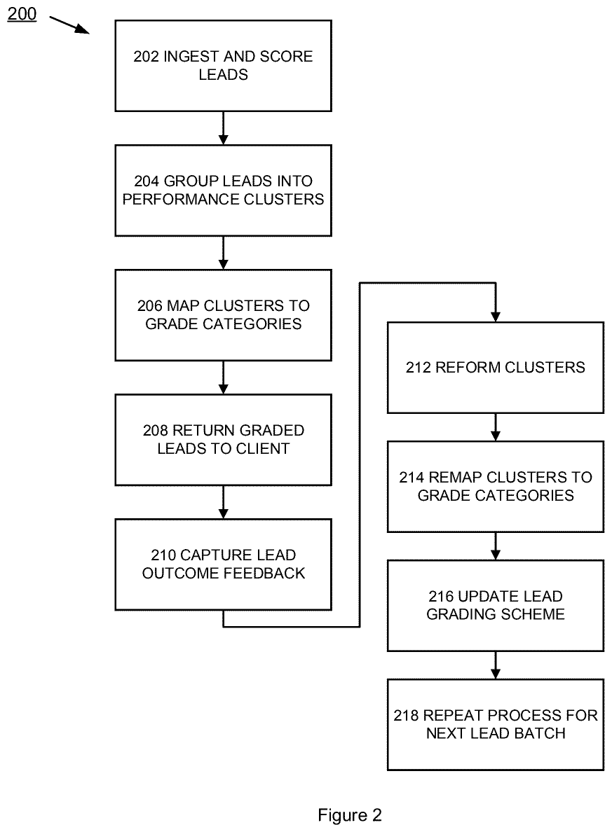

FIG. 2 depicts an example method 200 for real-time lead scoring model calibration in an illustrative embodiment. The process is initiated when new leads are ingested and scored by the binary classifier (step 202). The scored leads are grouped into performance clusters by the clustering module (step 204). The mapping module evaluates the composition and aggregate outcomes of each cluster and assigns them to graded categories (step 206). Graded leads are returned to the client system (step 208) where they are used to prioritize leads for sales outreach, set filtering rules, and trigger other lead engagement activities.

As scored leads convert to positive or negative outcomes, this feedback data is captured and used to reevaluate the clusters (step 210). If cluster compositions have shifted significantly, the clusters are reformed (step 212). The new cluster formations are mapped to grade categories (step 214) which updates the grading scheme used for subsequent batches of scored leads (step 216). The process repeats with each new batch of leads (step 218).

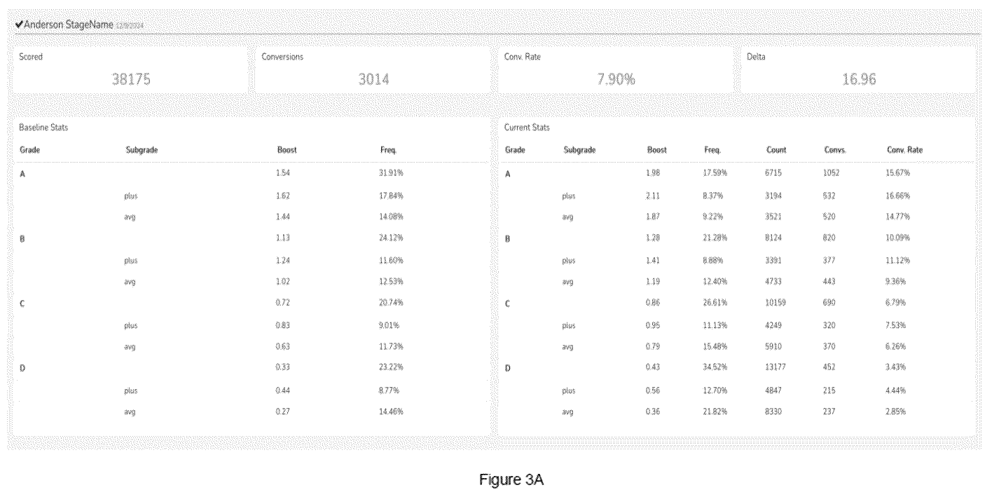

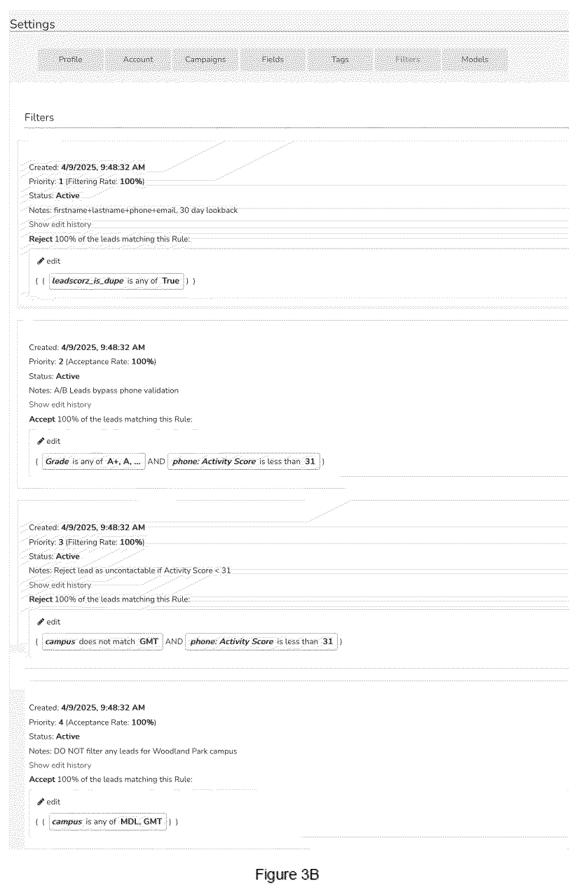

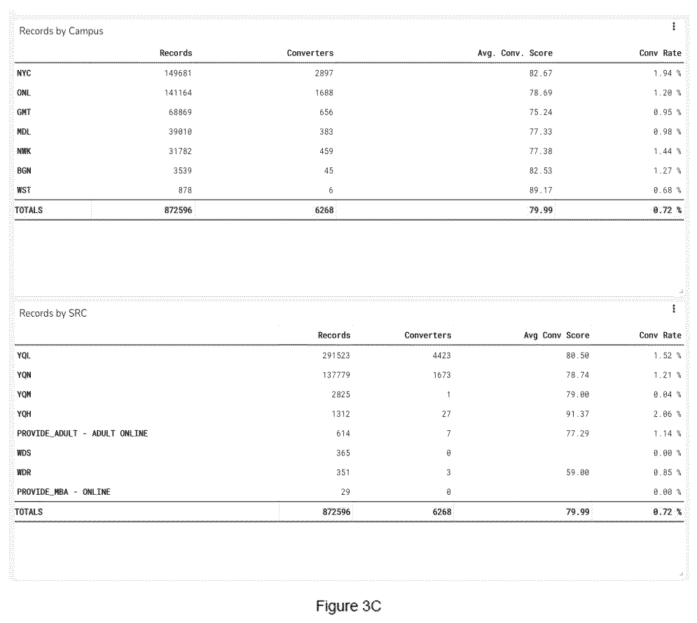

FIGS. 3A-3C show illustrative user interfaces of the dynamic lead scoring system for an education client in an illustrative embodiment. FIG. 3A compares the distribution of lead scores and conversion rates under the baseline binary classifier versus the current dynamically calibrated model, showing significant improvement. FIG. 3B depicts an interface for configuring lead filtering rules by source, program type, and campus, leveraging the graded lead scores. FIG. 3C shows actual lead conversion rates over time by source, enabling the client to monitor lead source performance and return on investment in purchased leads.

### FIG. 3A—Lead Scoring Model Performance Comparison

This screenshot shows a side-by-side comparison of lead score distributions and conversion rates for the client's baseline lead scoring model versus the dynamically calibrated model. The table on the left is a view of the baseline model results, and the table on the right shows current statistics based on real-time conversion capture from the client's CRM lead dispositioning. Applicant has determined that, for the baseline model, there is limited correlation between classifier scores. In contrast, the dynamically calibrated model shown on the right demonstrates a more linear relationship between grades and conversion rates, with the top A and A+ leads (for example) converting at a significantly higher rate than the leads graded as C leads, and C leads converting at a higher rate than D leads. There is a significant improvement in lead scoring accuracy achieved by using real-time feedback data to recalibrate the scoring model. The dynamically calibrated scores provide better differentiation between high and low quality leads based on the incorporation of new real-time information gained from lead nurturing.

### FIG. 3B—Lead Filtering and Prioritization Rules Interface

This screenshot depicts an interface that allows client users to define rules for filtering and prioritizing leads based on their demographic and behavioral attributes. In this example, the client is a college that sets filters for each campus, program and Affiliate (lead provider). The user can define rule conditions using dropdown menus for different attributes such as lead source, education program type, and campus location. For each rule, the user can specify which lead grades to include or exclude. Lead grades are determined dynamically by the calibrated lead scoring model. For example, a user could define a rule to only include A and B-graded leads from a specific set of lead providers, for a certain program type, at a given campus location. This allows them to continually target high-potential prospects even as the underlying definition of an “A” or “B” lead may evolve over time based on shifting conversion patterns.

### FIG. 3C—Lead Conversion Performance by Source Over Time

This chart displays real-time results over a period of time for each Affiliate (lead provider). Each line represents a different lead provider. This view allows the client to assess the quality of leads from each of their providers and identify changes in performance over time. Based on this data, the client could choose to allocate more of their budget to higher performing providers or deprioritize leads from providers whose quality has declined. The dynamic scoring model helps control for changes in the quality or composition of leads from each source over time. A provider whose leads were A and B-grade last quarter but are now C and D-grade would show a corresponding drop in conversion rate in this chart.

Together, these screenshots illustrate how the dynamic lead scoring system surfaces analytics and insights to end users and allows them to define flexible rules to take advantage of calibrated lead scores. The model outputs and decision tools help clients adapt their lead acquisition and outreach strategies in real-time to changing conversion patterns.

Importantly, the dynamic calibration process enables the system to adapt to changing lead behaviors and deliver predictive scores without requiring the binary classifier to be retrained. The relative grading scheme also allows decision rules and filters to be defined consistently even as the underlying lead distribution evolves over time. This provides significant computational efficiency gains versus having to retrain complex classification models on an ongoing basis. It also simplifies rule configuration for users.

Another key advantage is the system's ability to ingest real-time feedback data from client systems. Leads are automatically linked to downstream conversion events and sales outcomes captured in the client's CRM platform. This closed-loop architecture eliminates the need for manual outcome reporting and labelling of training data. The system can continuously evaluate the accuracy of its scores against actual results.

### AI and Machine Learning Models

At the core of the dynamic lead scoring system are the artificial intelligence (AI) and machine learning (ML) models used to predict lead conversion probability and segment leads into performance clusters. The system employs a two-stage modeling approach, with a supervised binary classification model followed by an unsupervised clustering algorithm.

The first stage model is a binary classifier trained to predict the probability that a given lead will convert, based on historical lead and conversion data. A variety of classification algorithms can be used for this purpose, depending on the characteristics of the dataset and prediction goals. Some common options include:
Logistic Regression: A linear model that estimates the probability of a binary outcome based on a weighted combination of input features. Logistic regression is computationally efficient and provides easily interpretable coefficients, but may underperform on complex, nonlinear datasets.
Decision Trees and Random Forests: Tree-based models that learn hierarchical rules to split the input data into homogeneous subgroups. Decision trees are intuitive and can handle both numerical and categorical variables but may be prone to overfitting. Random forests combine multiple decorrelated trees to improve generalization.
Gradient Boosted Machines (GBMs): Ensembles of weak prediction models (typically decision trees) that are trained sequentially to correct the errors of prior models. GBMs often achieve high accuracy and can automatically learn feature interactions but may be sensitive to noisy data and outliers.
Neural Networks: Layers of interconnected nodes that learn complex nonlinear functions of the input features. Neural networks, particularly deep learning architectures, can model subtle patterns in high-dimensional data, but require careful design and tuning and may have long training times.

The specific algorithm and hyperparameters are selected through cross-validation on historical data. The model is retrained periodically on an expanding dataset to capture changes in the underlying lead patterns.

The second stage model is an unsupervised clustering algorithm that groups leads into segments based on their predicted conversion probabilities and other relevant attributes. The system uses the k-means algorithm by default, which partitions the data into k clusters such that each observation belongs to the cluster with the nearest mean vector. The number of clusters k is chosen empirically to maximize the separation of conversion rates between clusters.

Alternative clustering algorithms that could be used include:
Hierarchical Clustering: Builds a tree-like structure of nested clusters by either merging smaller clusters into larger ones (agglomerative approach) or dividing larger clusters into smaller ones (divisive approach). This can reveal meaningful taxonomies in the lead data.
Density-Based Spatial Clustering of Applications with Noise (DBSCAN): Groups together points that are closely packed in feature space and marks points in low-density regions as outliers. DBSCAN can discover clusters of arbitrary shape and is robust to noise but requires careful parameter tuning.
Self-Organizing Maps (SOMs): A type of neural network that learns a lower-dimensional representation of the input data while preserving topological relationships. The result is a 2D grid of nodes, each representing a cluster of similar data points. SOMs can provide a visual map of the lead landscape.

The models are trained on a combination of raw lead attributes (e.g., source, campaign, geography, education history) and derived features engineered to capture behavioral patterns and contextual information. Some examples of engineered features in the education lead scoring context might include:
Engagement metrics like email opens, clicks, and website visits
Temporal features like time since last contact or time to first action
Aggregate features like total number of form submissions or call minutes
Ratios and trends comparing a lead's activity to population averages
Semantic information extracted from lead inquiry text using NLP techniques

The system includes automated feature engineering pipelines to transform raw lead and event data into model-ready features. It also has capabilities for data cleansing, normalization, and imputation of missing values.

To support real-time scoring, the trained models are deployed in a production environment using a scalable API architecture. The system is designed to handle high-volume streaming data and provide sub-second response times. Predictions and cluster assignments are cached in a high-performance database for efficient retrieval.

Monitoring and alerting functions are in place to track model performance over time and identify when models need to be retrained or updated. This includes tracking metrics such as overall model accuracy, cluster stability, and feature drift. The system can automatically trigger model retraining when performance falls below a specified threshold.

By combining machine learning, data engineering, and DevOps best practices, the system is able to deliver highly accurate and responsive lead scores while adapting to changing real-world patterns. The modular architecture allows new modeling approaches and data sources to be readily incorporated to drive continuous improvement. This is an example of what is now referred to as MLOPs.

### Customization of Lead Filtering and Prioritization

The lead filtering and prioritization rules can be customized for different user roles within the client organization. This allows each group to define rulesets tailored to their specific objectives and workflow. Examples of how rules might be customized by role include the following:

### Marketing Managers

Marketing managers are typically responsible for lead acquisition programs and optimizing the mix of lead sources and providers. They would likely define high-level rules to control which leads are forwarded to sales teams. For example:
Exclude a majority (e.g., 90%) of leads below a C grade from any source.
Only include A and B grade leads from providers with over 10% historical conversion rate.
Prioritize leads for high-value programs like graduate degrees over certificate programs.

These rules help ensure only the highest quality leads are passed to sales, while still providing coverage across key audience segments. Marketing can adjust grade cutoffs and provider mix to hit volume targets.

### Enrollment Counselors

Enrollment counselors are the front-line sales representatives responsible for contacting and nurturing leads. They often specialize in certain programs or campuses. Example rules for an enrollment counselor might include:
Only show leads for the Business and Nursing programs.
Prioritize A-grade leads, followed by B and C.
Focus on local campuses and exclude online programs.
Exclude leads from sources with under 5% conversion rate.

This allows each enrollment counselor to work leads that match their expertise and have the highest likelihood of converting. They can concentrate on the best leads without having to manually filter their queue.

### Admissions Directors

Admissions directors oversee enrollment for an entire campus or program. They are responsible for hitting overall admissions targets and managing team performance. Example rules for a director might include:
Review all A and B leads for the campus to monitor quality.
Route leads to specific counselors based on program or location.
Prioritize leads with the highest estimated enrollment probability.
Exclude duplicate leads and those missing key fields like phone number.

Directors can use rules to orchestrate lead flow across their teams and ensure the highest value opportunities are worked quickly. They can also adjust grade cutoffs to speed up or slow down outreach volume based on capacity.

The system provides a flexible rules engine that supports different filter conditions, prioritization logic, and user permissions. Rules can be defined at the global level by administrators and customized for each user role or individual. This allows clients to implement complex lead management strategies that align with their organizational structure and goals.

Some other key features related to rules customization include:
Rule templates that can be copied and modified for different user groups.
Ability to schedule rules to activate or deactivate on specific dates, such as when promotions start or stop.
Option to apply rules dynamically based on lead inventory levels and conversion rates.
Notifications and alerts when high-priority leads match a user's rule conditions.

By customizing filtering and prioritization rules for each stakeholder group, the system helps clients streamline their lead management processes and maximize conversion rates. Users can continuously adapt their criteria to changing market conditions and organizational needs without requiring manual intervention. This level of automated segmentation and targeting would be difficult to achieve with static rules or conventional lead scoring approaches.

### Conclusion

The dynamic lead scoring system disclosed herein offers a novel approach for maintaining predictive accuracy in production lead scoring applications by automatically calibrating scores based on real-time feedback data. Whereas conventional lead scoring models require frequent retraining to adapt to changing customer patterns, the present system achieves continuous adaptation without model retraining by dynamically adjusting the mapping of lead scores to performance grades. This provides significant computational efficiency gains and allows stable decision rules to be used by sales and marketing teams even as underlying lead conversion rates evolve.

The core technical advantages of the system arise from its unique two-stage modeling architecture, real-time feedback integration, and automated model monitoring capabilities. Decoupling the binary classification and clustering models allows dynamic calibration to be performed without the cost and complexity of retraining the classifier. Ingesting real-time conversion data from sales and marketing systems provides a continuous feedback loop for evaluating score accuracy and triggering grade updates. Monitoring overall model performance and data drift enables proactive retraining when needed to ensure scores remain viable.

The system is highly flexible and can be readily adapted to a variety of lead scoring applications beyond the education sector. The data processing pipelines, scoring API, and grade assignment logic can consume leads from any source system and industry. The models, decision rules, and user interfaces can be configured to align with each client's unique organizational structure, sales process, and business objectives.

More broadly, the invention can be generalized to any predictive modeling application where real-time feedback data is available and the business requires scores to adapt to changing patterns without model retraining. This could include other sales and marketing use cases such as product recommendations, customer churn prevention, or dynamic pricing. The core principles of two-stage modeling, real-time feedback loops, and automated model calibration can be applied to improve the accuracy and responsiveness of any machine learning system that operates on streaming data.

In summary, the disclosed dynamic lead scoring system represents a significant advancement over prior approaches in terms of accuracy, adaptability, and computational efficiency. The unique technical architecture enables businesses to deploy sophisticated lead prioritization models and decision rules that remain viable over time, even as customer behaviors and market conditions continuously evolve.

1. A system for dynamically calibrating a predictive lead scoring model in real time, comprising:
a lead intake module configured to receive lead data from one or more sources and to normalize the received lead data into a standardized schema;
a binary classifier configured to generate, for each lead, an initial probability score indicative of a likelihood that the lead will convert to a defined outcome;
a clustering module configured to cluster the leads into a plurality of performance-based segments according to at least the initial probability scores;
a mapping module configured to assign each segment to a grade category based on aggregate performance of the leads in each segment;
a feedback module configured to capture real-time outcome data for the leads, wherein the outcome data comprises indications of whether each lead converted; and
one or more processors communicatively coupled to a memory storing instructions that, when executed by the one or more processors, cause the system to:
(a) adjust the assignment of the performance-based segments to the grade categories in response to changes in the real-time outcome data; and
(b) update the grade category of subsequently received leads without retraining the binary classifier,
wherein said adjustment of the assignment of the performance-based segments is performed to calibrate lead scores in real time based on evolving lead behaviors and conversion outcomes.

2. The system of claim 1, wherein the clustering module is configured to apply a k-means clustering algorithm to group leads according to one or more attributes selected from the group consisting of: geographic location, source provider, demographic fields, and behavioral interaction data.

3. The system of claim 1, wherein the mapping module is further configured to designate a highest-performing segment as “A-grade” and lower-performing segments as consecutively lower grades, such that the grade categories maintain a relative ranking of leads over time.

4. The system of claim 1, wherein the binary classifier comprises a machine learning model selected from the group comprising:
a logistic regression model;
a decision tree or ensemble of decision trees;
a gradient boosting machine; and
a neural network.

5. The system of claim 1, further comprising an automated feature engineering pipeline configured to generate derived features from raw lead attributes, and to provide said derived features as inputs to the binary classifier.

6. The system of claim 1, wherein the feedback module is communicatively coupled to a client relationship management (CRM) platform configured to automatically receive positive or negative conversion events for each lead without manual data entry.

7. The system of claim 1, further comprising a rules engine configured to filter or prioritize leads based on the grade category, wherein filtering rules include selectively routing leads to specific user groups or excluding leads below a predetermined grade threshold.

8. A computer-implemented method for dynamically calibrating a predictive lead scoring model in real time without retraining a core classification model, the method comprising:
ingesting lead data for a plurality of leads and generating, by a binary classifier, an initial probability score for each lead;
clustering leads into a plurality of performance-based segments according to the initial probability scores and one or more additional lead attributes;
mapping each segment to a grade category based on an aggregate performance level of the leads assigned to that segment;
receiving real-time outcome data indicating whether each of the plurality of leads converted to a defined outcome;
adjusting the mapping from the performance-based segments to the grade categories based at least in part on the real-time outcome data; and
applying the adjusted mapping to newly ingested leads so as to assign a grade category without retraining the binary classifier.

9. The method of claim 8, further comprising executing a k-means clustering process to group the leads into performance-based segments and recalculating cluster centroids in response to the real-time outcome data.

10. The method of claim 8, wherein adjusting the mapping from the performance-based segments to the grade categories comprises automatically revising thresholds that define each grade category based on a relative ranking of segments'conversion rates.

11. The method of claim 8, further comprising extracting one or more derived features from raw lead data prior to generating the initial probability scores, the derived features including engagement metrics and historical lead interactions.

12. The method of claim 8, further comprising providing a user interface for configuring lead filtering or prioritization rules based on the assigned grade categories, wherein said rules specify inclusion or exclusion of leads from sales outreach.

13. The method of claim 8, wherein the step of receiving real-time outcome data includes automatically ingesting lead disposition events from a client relationship management (CRM) system.

14. The method of claim 8, further comprising monitoring a performance metric of the binary classifier over time and triggering an alert condition to retrain the binary classifier when the performance metric falls below a predefined threshold.
